(19) United States
(12) Patent Application Publication
(10) Pub. No.: US 2024/0303482 A1
(43) Pub. Date: Sep. 12, 2024

(54) PRIORITIZING TRAINING EXAMPLES WHEN TRAINING CLASSIFIERS

(71) Applicant: Robert Bosch GmbH, Stuttgart (DE)

(72) Inventors: Laura Beggel, Stuttgart (DE); William Harris Beluch, Stuttgart (DE)

(21) Appl. No.: 18/182,215

(22) Filed: Mar. 10, 2023

(30) Foreign Application Priority Data
Apr. 1, 2022 (DE) 10 2022 203 291.8

(51) Int. Cl. G06N 3/08; G06N 3/0455

(52) U.S. Cl. CPC G06N 3/08; G06N 3/0455

(57) ABSTRACT

A method for prioritizing training examples in a training data set for a classifier designed to map measurement data to classification scores with respect to classes of a predetermined classification. In the method includes: the classifier is trained with the training examples from the training data set; modifications are generated for at least one training example; classification scores are respectively determined from the modifications by means of the classifier; a priority of the training example to which the modifications belong is determined from the distribution of these classification scores.

### CROSS REFERENCE

The present application claims the benefit under 35 U.S.C. § 119 of German Patent Application No. DE 10 2022 203 291.8 filed on Apr. 1, 2022, which is expressly incorporated herein by reference in its entirety.

### FIELD

The present invention relates to training classifiers that map measurement data, such as images, to classification scores with respect to one or more classes.

### BACKGROUND INFORMATION

An important task in the evaluation of measurement data is classification. For example, images taken during the quality inspection of manufactured products are mapped by means of a classifier to classes representing “OK,” “Not OK” (NOK) quality levels or any intermediate values. When guiding vehicles in an at least partly automated manner, images from the vehicle environment are classified as to which objects, such as other road users, traffic signs, or roadway boundaries, these images show.

Classifiers need to be trained with a variety of training examples. In doing so, it is often a challenge that there are too few training examples for some situations where a correct classification result is particularly important.

### SUMMARY

In according to the present invention, a method for prioritizing training examples in a training data set for a classifier is provided. This classifier is designed to map measurement data to classification scores with respect to classes of a predetermined classification.

According to an example embodiment of the present invention, the method starts from a given training data set with training examples. The classifier is first trained with the training examples from the training data set. In this training, it is not important that the classifier provides correct results but only that the classifier, as a signal generator, is “diverted from its intended use” as to whether a training example is an ordinary training example or a rare corner case.

Modifications are now determined for at least one training example for which a priority is to be determined. Preferably, this takes place for all training examples in the training data set so that each of these training examples is assigned a priority and the training examples can be handled differently according to their respective priorities.

A modification of a specific training example is generally understood to mean an object that is not identical to this training example but belongs to the distribution defined by all training examples and is also characterized by the specific training example. For example, modifications of images can be generated by image processing operations that leave the semantic content of the image substantially unchanged. Examples of such operations are blurring or adding noise.

From the modifications generated for the respective training example, classification scores are respectively determined by means of the classifier. A priority of the training example to which the modifications belong is determined from the distribution of these classification scores.

It has been found that the distribution of the classification scores of modifications of a training example is correlated with whether this training example is an ordinary training example or a particularly rare, so-called corner case.

An ordinary training example is ordinary in the literal sense because it is in the “company” of many similar training examples. For example, when training a classifier for images of traffic situations, there will be innumerable examples of situations in which a traffic light- and/or traffic sign-controlled intersection is ahead. Accordingly, modifications of such training examples in the space of the training examples will probably land in an area that is covered overall with a high density of training examples. In such an area, the training of the classifier generalizes particularly well. The classification scores for several modifications of one and the same training example will therefore deviate comparatively little from one another and from the classification scores for the original training example.

An exceptional training example, on the other hand, is more or less “out on a limb” in the space of the training examples, without there being other similar training examples in the vicinity. For example, there may only be a single training example of a traffic situation in which a road user, who could collide with one's own vehicle, at a poorly visible intersection or side road can only be identified with difficulty in a traffic mirror. However, in an area in which there are only sporadic training examples, the training of the classifier does not generalize well. Modifications of a training example that are in this area will therefore result in classification scores that deviate strongly from one another and from the classification scores for the original training example.

Exceptional training examples are particularly important in many applications so that a classifier can satisfactorily achieve the task given to it. In the example of the classifier for images of traffic situations, whether the training data set contains an ordinary training example more or less has comparatively little influence on the result of the training. For example, a specific image of an intersection can usually be omitted without any problems because there are still enough other images that show a comparable situation. On the other hand, the one image of a situation in which a road user can be identified only via the traffic mirror can be indispensable for the classifier and a downstream control system for one's own vehicle to master the situation.

With the method according to the present invention presented herein, exceptional training examples can be assigned high priorities. Training examples with these high priorities can be preferred whenever a selection is to be made when compiling a training data set. In this way, it can be ensured that the classifier trained with the training data set also masters unusual situations.

One motivation to make a selection between training examples and to not simply use all available training examples is that the training time and memory requirement for the training of the classifier depends on the number of training examples. There is often only a limited time budget available for the training. The costs and effort of storing and transferring the training data set are also based on the volume thereof. Conversely, by now creating a possibility to filter out the most important training examples from a large amount of training examples, massively more training examples can initially be captured than necessary to subsequently make a “best of” selection.

In this context, determining priorities for the training examples allows, under the constraint of a numerically predetermined quota of training examples to be considered, to generate a training data set that provides the trained classifier with optimal performance in its intended application.

In a particularly advantageous embodiment of the present invention, the priority of the training example is set the higher, the more strongly the classification scores determined from the modifications of this training example spread and/or deviate from classification scores for the original training example. As explained above, this spread, or this deviation, is a measure of how well the previous training of the classifier generalizes. The ability to generalize, in turn, is correlated with whether or not there are even more training examples in the neighborhood of the training example in question. For example, if several modifications of several training examples each result in classification scores that only spread with uncertainties on the order of 0.1, and modifications of another training example, on the other hand, result in classification scores that spread with an uncertainty of 0.9, the latter training example is highly likely to be a rare corner case.

According to an example embodiment of the present invention, the priority of a training example can be set, in particular, using, for example, an entropy determined from the classification scores for the modifications. This entropy is a measure of the uncertainty with which these classification scores are fraught.

According to an example embodiment of the present invention, particularly advantageously, the training of the classifier and the generation of the modifications are coordinated with one another such that modifying the training examples alters at least one characteristic of the training examples with respect to which the trained classifier is not invariant. In this way, as described above, the modifications may serve as a “sensor” for whether or not the training of the classifier generalizes well in the local area around the specific training example.

As explained above, modifications may be generated, for example, by image processing operations. These operations are independent of the specific domain to which the images belong. However, the modifications are particularly advantageously generated using a machine learning model. This machine learning model can take into account the particularities of the domain of the training examples. In this way, with the modifications, it can be better measured how well the training of the classifier generalizes in the neighborhood around a training example with respect to an intended application.

For example, at least one modification may be generated by means of a generative model conditioned to the training example. Such a generative model may, for example, be a generator of a generative adversarial network (GAN). Such a generator maps a sample drawn from a latent space or a distribution to the desired modification and has been trained in the GAN together with a discriminator. The task of the discriminator is to binarily classify a given example of measurement data as to whether or not this example belongs to the distribution defined by the training examples. The generator therefore specifically generates modifications that belong to this distribution. In doing so, conditioning to the original training example ensures that the modification is actually also characterized by the original training example and can thus function as a modification of this specific training example.

Alternatively or in combination thereto, by means of an encoder of an encoder/decoder assembly trained as an autoencoder, training example can be converted into a representation with reduced dimensionality. A sample can then be drawn from a neighborhood of this representation, and this sample can be converted into the desired modification by means of the decoder. The encoder/decoder assembly is trained as an autoencoder to convert training examples into representations by means of the encoder and to then reconstruct therefrom the original training examples by means of the decoder.

In a particularly advantageous embodiment of the present invention, the training examples comprise images. Images are very highly dimensional and have very large variability. Even two images taken one directly after the other of one and the same scenery are generally not identical. In order to ensure that among all these variations, the desired one is always recognized, classifications for images are therefore trained with an extremely large amount of training examples. With the aid of the prioritization proposed herein, it can be selected which of these training examples are most important and which training examples may possibly be omitted.

For example, the classification classes may, in particular, represent
objects recognized in the image, and/or
features, defects, or damages recognized in the image, and/or
an overall rating of a scenery shown in the image; and/or
a quality rating of a finished product shown in the image
   The finer the division into classes is, the more likely it may be that there are only a few training examples, or even only a single training example, for a class in the training data set.

As explained above, in a particularly advantageous embodiment of the present invention, training examples are selected using the determined priorities. These selected training examples are included in a new, reduced training data set. In particular, a numerically predetermined quota of training examples can be used optimally with regard to the classification accuracy achieved by the classifier after the training with the reduced training data set. This does not rule out that the new, reduced training data set contains other training examples. However, it is ensured that at least the most important training examples are contained.

For example, training examples whose priorities satisfy a predetermined criterion may be selected to be in any case contained in the reduced training data set. Further training examples can subsequently be randomly selected from the training data set and likewise included in the new, reduced data set. Compared to conventional reduction techniques, which select training examples purely randomly without using priorities, it is hereby ensured that, by reducing the training data set, capabilities of the classifier dependent on particular, crucial training examples are not suddenly lost.

In a further, particularly advantageous embodiment of the present invention, a more balanced distribution of the numbers of the training examples over the available classes is established in the new, reduced training data set than is present in the original training data set. For example, in quality control, where manufactured products are binarily divided into the “OK” and “Not OK=NOK” classes, there is often a very strong excess of the training examples for the “OK” class, because it is usually the case that the manufacturing process works and the products are in order. However, attempting to compensate for this imbalance between the “OK” and “NOK” classes by omitting training examples for the “OK” class may then result in the elimination of important training examples of the “OK” class on which, for example, the recognition of particular features exclusively depends. This is advantageously avoided by prioritizing the training examples as proposed herein.

Advantageously, according to an example embodiment of the present invention, the classifier is re-trained and/or further trained with the new, reduced training data set. By prioritizing the training examples, this training requires significantly less computing time and memory space. At the same time, however, the accuracy of the classifier is not significantly degraded. For example, the accuracy can be measured using test or validation data that were not the subject of the training. Accuracy may possibly even be improved by the reduced training data set suppressing a tendency to overfitting (“memorization”) of the training examples.

The ultimate goal is to use the classifier as intended and to benefit from the advantages embodied in the reduced training data set during this use. Advantageously, measurement data recorded by at least one sensor are therefore supplied to the re-trained and/or further trained classifier. A control signal is determined from the output of the classifier. This control signal is used to control a vehicle, an area monitoring system, a quality control system, and/or a medical imaging system. Since the reduced training data set used contains the important training examples for rare corner cases in any case, it is ensured that the classifier masters these corner cases. This increases the probability that the response of the respectively controlled system triggered by the control signal is appropriate to the situation embodied by the measurement data.

The method may be entirely or partially computer-implemented. The present invention therefore also relates to a computer program including machine-readable instructions which, when executed on one or more computers and/or compute instances, cause the computer(s) and/or compute instance(s) to perform the method described herein. In this sense, control devices for vehicles and embedded systems for technical devices that are likewise capable of executing machine-readable instructions are also to be regarded as computers. In particular, compute instances may, for example, be virtual machines, containers, or other execution environments for executing program code in a cloud.

Likewise, the present invention also relates to a machine-readable data storage medium and/or to a download product including the computer program. A download product is a digital product that can be transmitted via a data network, i.e., can be downloaded by a user of the data network, and may, for example, be offered for sale in an online shop for immediate download.

Furthermore, one or more computers and/or compute instances may be equipped with the computer program, with the machine-readable storage medium, or with the download product.

Further measures improving the present invention are described in more detail below on the basis of the figures, together with the description of the preferred exemplary embodiments of the present invention.

### BRIEF DESCRIPTION OF THE DRAWINGS

FIG. 1 shows an exemplary embodiment of the method 100 for prioritizing training examples 2a.

FIG. 2 shows an illustration of the difference between ordinary training examples 2a (situation A) and rare corner cases (situation B).

### DETAILED DESCRIPTION OF EXAMPLE EMBODIMENTS

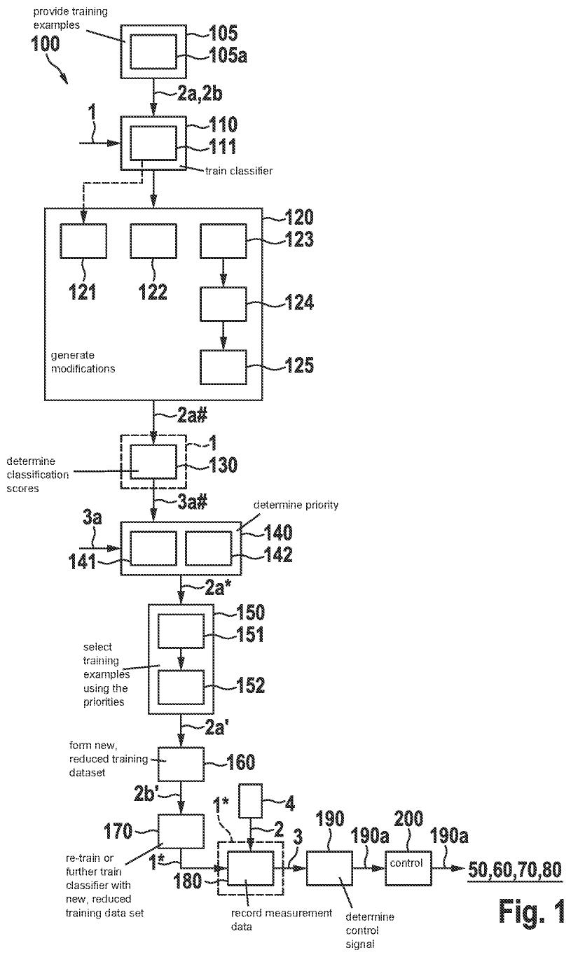

FIG. 1 is a schematic flow chart of an exemplary embodiment of the method 100 for prioritizing training examples 2a in a training data set 2b for a classifier 1.

According to block 105, the training examples 2a may, in particular, comprise images, for example. For example, according to block 105a, the classification classes may then, in particular, represent
objects recognized in the image, and/or
features, defects, or damages recognized in the image, and/or
an overall rating of a scenery shown in the image; and/or
a quality rating of a finished product shown in the image

In step 110, the classifier 1 is trained with the training examples 2a from the training data set 2b.

In step 120, modifications 2a #are generated for at least one training example 2a.

In step 130, classification scores 3a #are respectively determined from the modifications 2a #by means of the classifier 1.

In step 140, a priority 2a* of training example 2a to which the modifications 2a #belong is determined from the distribution of these classification scores 3a #.

In step 150, training examples 2a′ are selected using the determined priorities 2a*.

In step 160, a new, reduced training dataset 2b′ is formed from these selected training examples 2a′.

In step 170, the classifier 1 is re-trained and/or further trained with the new, reduced training data set 2b′. The state of the classifier 1 after this training is denoted by reference sign 1*.

In step 180, measurement data 2 recorded by at least one sensor 4 are supplied to the re-trained and/or further trained classifier 1*.

In step 190, a control signal 190a is determined from the output of the classifier 1*, said output containing classification scores 3.

In step 200, a vehicle 50, an area monitoring system 60, a quality control system 70, and/or a medical imaging system 80 are controlled by means of this control signal 190a.

According to blocks 111 and 121, the training of the classifier 1 and the generation of the modifications 2a #can be coordinated with one another such that modifying the training examples 2a alters at least one characteristic of the training examples 2a with respect to which the trained classifier 1 is not invariant.

According to block 122, at least one modification 2a #may be generated by means of a generative model conditioned to the training example 2a.

According to block 123, by means of an encoder of an encoder/decoder assembly trained as an autoencoder, the training example 2a can be converted into a representation with reduced dimensionality. According to block 124, a sample can then be drawn from a neighborhood of this representation. According to block 125, this sample can then be converted into the desired modification 2a #by means of the decoder.

According to block 141, the priority 2a* of the training example 2a can be set the higher, the more strongly the classification scores 3a #determined from the modifications 2a #of this training example 2a spread and/or deviate from classification scores 3a for the original training example 2a.

According to block 142, the priority 2a* can be set using an entropy determined from the classification scores 3a #for the modifications.

According to block 151, training examples 2a′ whose priorities 2a #satisfy a predetermined criterion can be selected for inclusion in the reduced training data set 2b′. According to block 152, further training examples 2a can then be randomly selected from the training data set 2b.

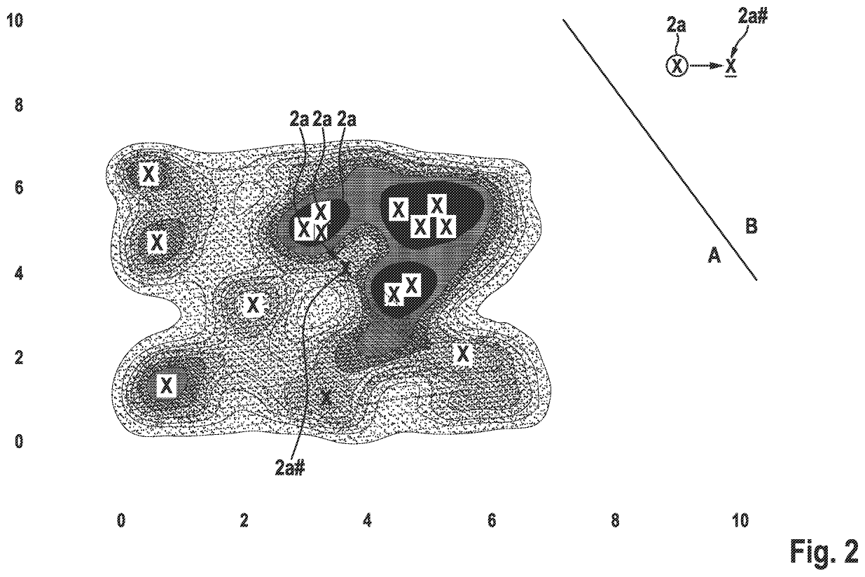

FIG. 2 illustrates the difference between ordinary training examples 2a and rare corner cases. FIG. 2 is a heat map in a feature space drawn in only two dimensions for the sake of simplicity. The intensity plotted in the heat map represents the strength of representations learned in particular areas of the feature space.

According to situation A, ordinary training examples 2a are in the “company” of further training examples 2a. When modifications 2a #are generated therefrom, they are still in that portion of the feature space in which strong representations have been learned.

According to situation B, a training example 2a representing a rare corner case is “out on a limb.” When a modification 2a #is generated therefrom, that portion of the feature space in which strong representations have been learned is left entirely. The modifications 2a #are thus in “unlearned” territory, and the classification scores 3a #determined for them will spread correspondingly strongly.

What is claimed is:

1. A method for prioritizing training examples in a training data set for a classifier configured to map measurement data to classification scores with respect to classes of a predetermined classification, comprising the following steps:
training the classifier with the training examples from the training data set;
generating modifications for at least one training example of the training examples;
determining respective classification scores for the modifications using the classifier; and
determining a priority of the training example to which the modifications belong from a distribution of the respective classification scores.

2. The method according to claim 1, wherein the priority of the training example is set higher the more strongly the respective classification scores determined for the modifications of the training example spread and/or deviate from classification scores for the training example.

3. The method according to claim 1, wherein the priority is set using an entropy determined from the respective classification scores for the modifications.

4. The method according to claim 1, wherein the training of the classifier and the generation of the modifications are coordinated with one another such that modifying the training example alters at least one characteristic of the training example with respect to which the trained classifier is not invariant.

5. The method according to claim 1, wherein at least one of the modifications is generated using a generative model conditioned to the training example.

6. The method according to claim 1, wherein at least one of the modifications is generated by:
converting the training example into a representation with reduced dimensionality using an encoder of an encoder/decoder assembly trained as an autoencoder,
drawing a sample from a neighborhood of the representation, and
converting the sample into the modification using a decoder of the encoder/decoder assembly.

7. The method according to claim 1, wherein the training examples include images.

8. The method according to claim 7, wherein the classes of the predetermine classification represent:
objects recognized in the image, and/or
features, defects, or damages recognized in the image, and/or
an overall rating of a scenery shown in the image; and/or
a quality rating of a finished product shown in the image.

9. The method according to claim 1, wherein training examples of the training data set are selected using the determined priorities, and the selected training examples are included in a new, reduced training data set.

10. The method according to claim 9, wherein:
training examples of the training data set whose priorities satisfy a predetermined criterion are selected, and
further training examples are randomly selected from the training data set and are included in the new, reduced data set.

11. The method according to claim 9, wherein a more balanced distribution of numbers of the training examples over the available classes is established in the new, reduced training data set than is present in the training data set.

12. The method according to claim 9, wherein the classifier is re-trained and/or further trained with the new, reduced training data set.

13. The method according to claim 12, further comprising:
supplying measurement data recorded by at least one sensor to the re-trained and/or further trained classifier;
determining a control signal from output of the classifier; and
controlling, using the control signal: a vehicle, and/or an area monitoring system and/or a quality control system and/or a medical imaging system.

14. A non-transitory machine-readable storage medium on which is stored a computer program for prioritizing training examples in a training data set for a classifier configured to map measurement data to classification scores with respect to classes of a predetermined classification, the computer program, when executed by one or more computers and/or compute instances, causing the one or more computers and/or compute instances to perform the following steps:
training the classifier with the training examples from the training data set;
generating modifications for at least one training example of the training examples;
determining respective classification scores for the modifications using the classifier; and
determining a priority of the training example to which the modifications belong from a distribution of the respective classification scores.

15. One or more computers and/or compute instances configured to prioritize training examples in a training data set for a classifier configured to map measurement data to classification scores with respect to classes of a predetermined classification, the one or more computers and/or compute instances configured to:
train the classifier with the training examples from the training data set;
generate modifications for at least one training example of the training examples;
determine respective classification scores for the modifications using the classifier; and
determine a priority of the training example to which the modifications belong from a distribution of the respective classification scores.
